(19) United States
(12) Patent Application Publication
(10) Pub. No.: US 2008/0265144 A1
(43) Pub. Date: Oct. 30, 2008

(54) Deflected Light Beam Network Barrier

(76) Inventors: Shmuel Shaked, Zichron Yaacov (IL); Gil Lederman, Tel-Aviv (IL); Igal Regev, Haifa (IL)

Correspondence Address: YORAM TSIVION, P.O. BOX 1307, PARDES HANNA, 37111, IL

(21) Appl. No.: 12/088,096

(22) PCT Filed: Sep. 25, 2006
(86) PCT No.: PCT/IL06/01120

§ 371 Date: Mar. 26, 2008

Related U.S. Application Data
(60) Provisional application No. 60/596,465, filed on Sep. 26, 2005.
(60) Provisional application No. 60/596,929, filed on Oct. 31, 2005.
(60) Provisional application No. 60/597,171, filed on Nov. 15, 2005.

(51) Int. Cl. H01J 40/14

(52) U.S. Cl. 250/221

(57) ABSTRACT

A system (FIG. 1) for secluding a zone in which it is completely surrounded by a light beam barrier (14) such that any object or person striving to cross the barrier invokes an alarm if the crossing complies with various conditions The barrier is a continuous light beams formed using one light source (12) The light beam is projected from the source at one end of a path, and finally impinging on a light detector (22) The deflected light beam of the invention forms an envelope of a voluminous virtual body, that which is regarded as a seclude volume.

### TECHNICAL FIELD OF THE INVENTION

The present invention relates to optical alarm systems in general and more particularly, to optical systems detecting intrusion of objects and persons into secluded zone delimited by a barrier created by a network of light beams.

### BACKGROUND ART

The present invention relates to protective appliances that secure specific zone against unintentional or intentional access. The seclusion of designated areas is sometimes a necessity that requires solutions such as fences and even human guards. A life guard who watches little children or pets from entering into a swimming pool is a typical example for such designated area seclusion. A swimming pool life guard is may not be attentive optimally over his or her entire working hours. The attention of a lifeguard may distracted by events in the environment, such that his/her attention to the pools security is diminished to some degree. In such case little children could jump into the swimming pool and even drown without the life guard notice. In order that a life guard will notice that, a system that alert a swimming pool life guard that an unauthorised child is entered into a swimming pool is called for.

### BRIEF DESCRIPTION OF THE DRAWINGS

The present invention will be understood and appreciated more fully from the following detailed description taken in conjunction with the appended drawings in which:

FIG. 1 is a schematic description diagram of a single layer of a zone secluded by the system of the invention;

FIG. 2 is a schematic description of the set of deflectors and light source/receiver secluding a volume in accordance with the system of the invention;

FIG. 3A is a schematic depiction of a light beam configuration using deflection mirrors to separate two layers without a separate detection mechanism;

FIG. 3B is a schematic depiction of a light beam configuration using deflection mirrors to separate two layers with a separate detection mechanism;

FIG. 4 is a schematic description of a construction for dual light source alignment;

FIG. 5 is a schematic description of the dual light source construction of an embodiment of the invention showing the two light rays converging in the beam splitter and emerging in collinear.

### DESCRIPTION OF THE INVENTION

In accordance with embodiments of the present invention a secluded zone is completely surrounded by a light beam barrier such that an object or person crossing the path of light invokes an alarm. The barrier is a continuous one or more light beams formed using typically one light source. The light beam is projected from the source at one end of a path, further deflected at specific sites hereinafter referred to as nodes of the network, and finally impinges on a light detector. The deflected light beam of the invention forms an envelope of a voluminous virtual body, that which is regarded as a seclude volume.

There are several uses of the system of the invention, which is suitable for deterring or warning in the case that an object, person, or animal crosses the light beam for a period of time defined by the operator or preset in the production facility. A typical example for use is that of an invisible fence guarding a swimming pool against unsupervised entrance of little children. The height and effective vertical active area of the sensitive light beam can be accommodated to children, adults, household pets etc, by adding more layers of reflectors and/or changing their height.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In accordance with some embodiments of the present invention, as a default option for deflection of the light beam, planar mirrors may be used to deflect the continuous light beam as described above. However, non-planar lo mirrors can be used for the same purpose, prisms and beam splitters for splitting the light beams.

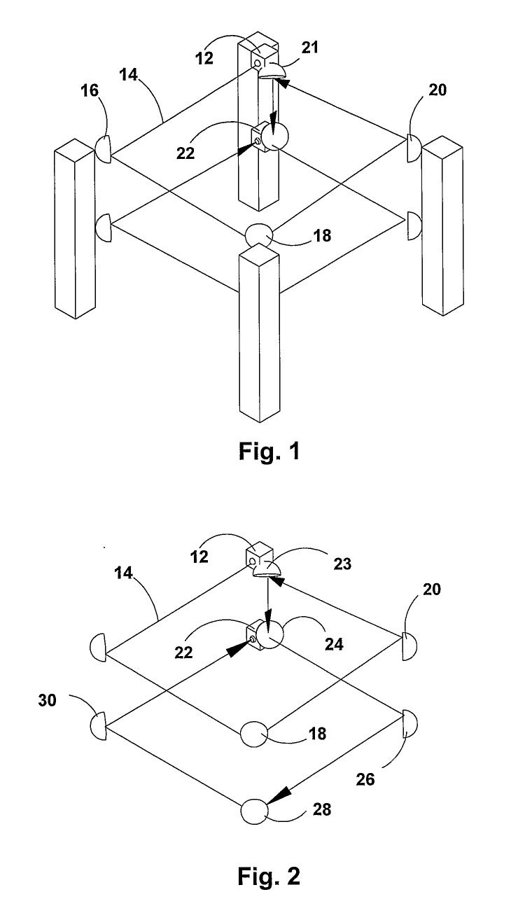

Deflection in a same plane is described in FIG. 1 to which reference is now made. Light source 12 projects light in the form of beam 14 that is deflected once by mirror 16, and again by mirror 18. It is then deflected by mirror 20 reaching substantially to mirror 21. In this manner, all the area defined the four nodes, namely light emitter 12, mirrors 16, 18 and 20. Since the light beam is received by light receiver 22, any breach in the continuity of light beam 14 is detected by detector in receiver 22 further to be interpreted by an analyzing circuit (not shown) and produce an alarm signal under predefined conditions. The deflection of the light beam in accordance with the present invention can be used to define not only planes but also three dimensional bodies as described in FIG. 2. Light emanating from source 12 is deflected after completing an entire circle in an upper layer. The deflection is brought about by deflector 23 having the inclination angle accommodated for pointing the light beam to deflector 24. This deflector is a node in a lower plane including reflectors 26, 28, 30 and finally receiver 22. This receiver contains a detector that monitors the presence of the light beam. A controller, not shown, analyses the energy received by the detector and is set to activate an alarm if the light beam is interrupted for a period of time longer them a predefined threshold. For the sake of clarity, the deflectors and light source/receiver are shown without the respective supporting poles. All of the deflectors participating in receiving and sending of a single beam of light are referred to as part of a set.

Light Sources

Useful and available devices are laser sources powered by a battery or by power line connection. Light emitting diodes (LEDs) may also serve in a device in accordance with the application. The light source most typically used is an infrared (IR) laser source. The IR laser source is advantageous over visible light, as the IR is less prone to disturbance by sunlight which conveys most of its energy in the visible region. Alignment is required in order to obtain an unbroken continuum of a light beam starting from a light source and ending in a light detector. However, the invisible light does not lend itself easily to be used in the aligning of the deflecting mirrors.

Detectors and Control Circuits

Any light detecting system sensitive in both energy level and frequency or frequency limits is an option. The control unit monitors and analyses the output signal of the receiver/detector and issues a warning or an alarm signal to an appropriate device that notifies or set off an alarm.

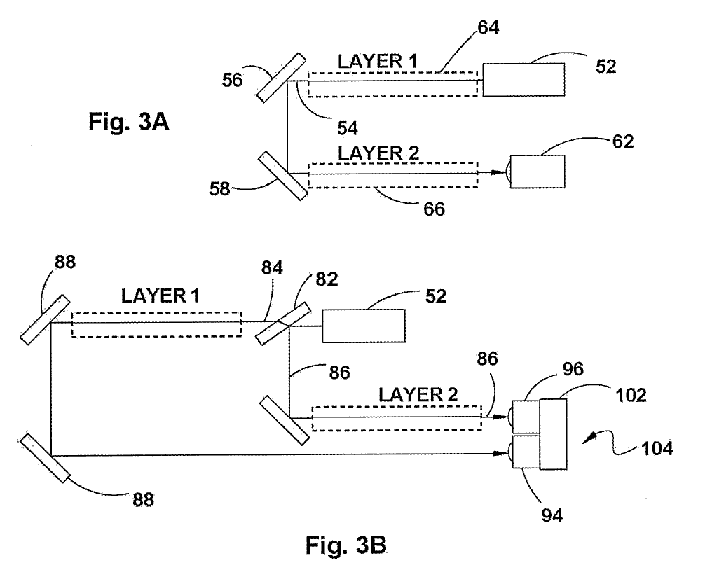

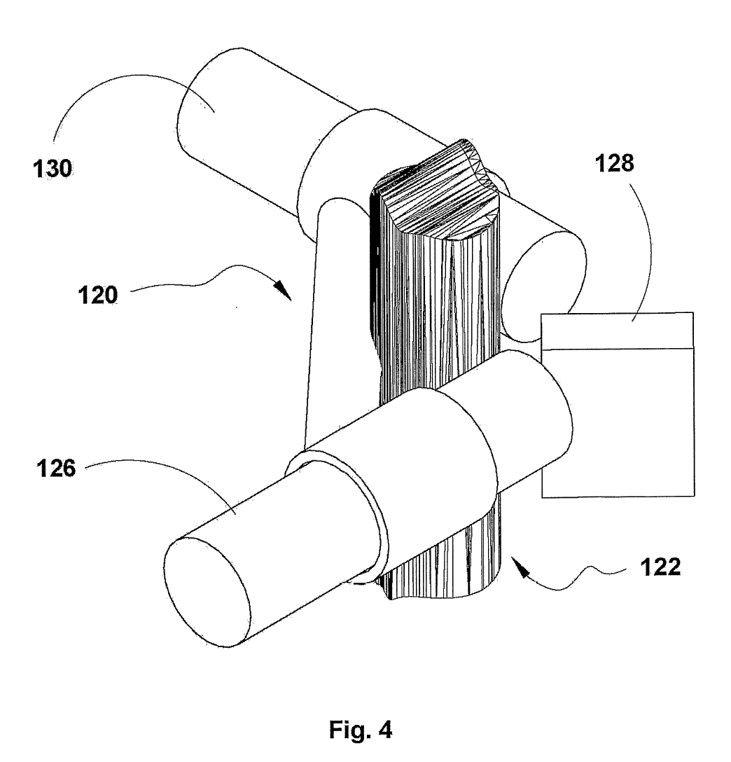

In some cases it is desired that the different layers of light rays be detected separately, meaning the top layer has a separate alarm control, the lower layer another control, and so on. Thus, if the light beam in top layer is interrupted, the alarm would be engaged using a different detector than if a lower 10 layer light beam is interrupted. In another preferred embodiment of the invention two detectors are used to detect separately two different layers. To implement this configuration economically, mirrors are used and two detectors coupled to form a single processing device. This is illustrated schematically in FIGS. 3A-B to which reference is now made. In FIG. 3A, without a separate detection mechanism, laser source 52 sends light ray 54 in the direction of deflector 56. Deflector 58 sends the light ray to receiver 62. Layer 1, designated by dashed box 64, and layer 2 marked by dashed box 66 share a common continuum of light beam. Any interruption of the light in either layer would be equally sensed by receiver 62. In FIG. 3B a separate detection is applied to each layer and a beam splitter is added to the configuration. Laser source 52 sends a light ray to beam splitter 82. The light beam splits into two secondary beams, beam 84 is utilized for layer 1, and beam 86 is utilized within the framework of layer 2. A series of deflectors 88 send beam 84 to detector 94 which may be installed anywhere convenient and practical. Detector 96 responds to light beam 86 and thus can indicate a discontinuity in beam 86. Detector 94 responds to any discontinuity in beam 84. Both detectors 94 and 96 are connected typically to single controller 102 which analyses the signal produced by each detector. In this embodiment typically light receiver 104 includes the number of detectors which correspond to the number of separate layers all connected to a controller circuit that serves all detectors. In this embodiment each layer has a set of deflectors required to define the limits of the segregated zone as defined for each layer. The projection of the circumference in each layer may be equal to the projection of the circumferences of the other layers but other geometries are valid. To separate the beams, split fiber-optic bundle may be used.

System Alignment

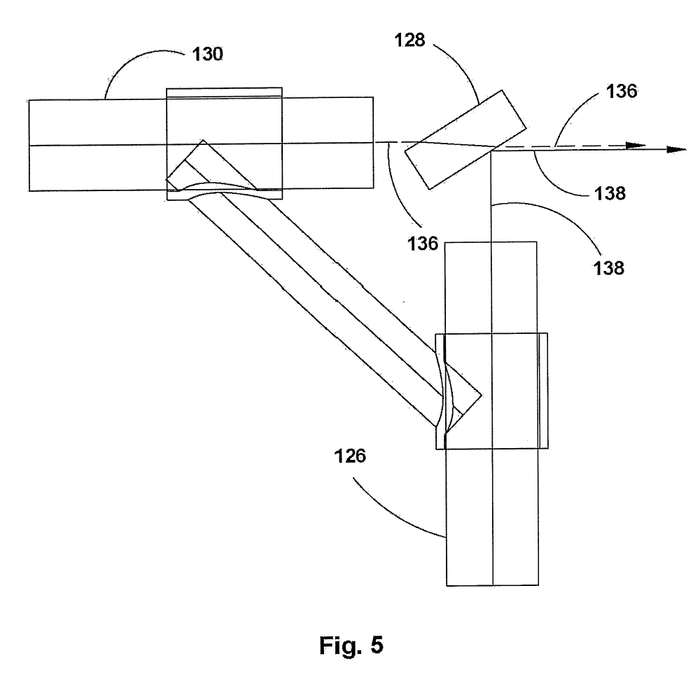

In such cases as the system of the invention uses an IR light source for creating the continuous light beam barrier, an additional light source is used for the alignment of the light deflectors. As can be seen in FIG. 4 to which reference is now made, dual light source (DLS) 120 is disposed on a supporting device 122, typically a pole. IR laser light source 126 points at beam-splifter 128. A visible laser light source 130 points also towards beam-splitter 128, such that the two beams of the respective laser sources emerging in parallel and are collinear. In FIG. 5 to which reference is now made, a schematic top view description of the laser rays is given, as they align in the beam splitter. IR laser light source 126 points at beam-splitter 128. Visible laser light source 130 points also towards beam-splitter 128, such that the two beams of the respective laser sources align in parallel. Beam 136 designated by a dashed line, enters beam-splitter 128 in such an angle that it emerges parallel to the angle of entry. Beam 138, in contrast, is reflected by beam-splitter 128 such that the outgoing section of the beam is at an angle to the incoming section of the beam. The parallel path of the two beams allows the user to adjust the angles' positions of the respective deflecting mirrors such that a continuum of a beam of light is kept from the light source to the light detector. When the alignment procedure is completed, the visible light source can be turned off.

It will be appreciated that the present invention is not limited by what has been described hereinabove and that numerous modifications, all of which fall within the scope of the present invention, exist. It will be appreciated by persons skilled in the art that the present invention is not limited by what has been particularly shown and described herein above. Rather the scope of the invention is defined by the claims which follow:

1. A system for secluding a zone comprising:
at least one set of deflectors;
at least one light source;
at least one light detector for detecting light of said at least one light source, said light deflected by said set of deflectors, and
at least one analysing circuit connected to said at least one detector, for responding to a discontinuity in said deflected light.

2. A system for secluding a zone as in claim 1 wherein said light source is a laser source.

3. A system for secluding a zone wherein said set of deflectors and said light source and said detector segregate a volume.

4. A system for segregating a zone as in claim 1 wherein said deflectors are mirrors.

5. A system as in claim 1 wherein two light sources are used, a first, visible light source is used for aligning said deflecting mirrors, and a second IR light source is used to maintain an unbroken light barrier.

6. A system for secluding a zone as in claim 1 further comprising a light beam splitter for splitting the beam of said source into two secondary beams; one for a layer, and wherein each of said secondary beams reaches a different light detector after being deflected by a respective set of deflectors.

7. A system for secluding a zone as in claim 6 and wherein both of said light detectors are connected to a single controller.
